(19) United States
(12) Patent Application Publication
(10) Pub. No.: US 2014/0007899 A1
(43) Pub. Date: Jan. 9, 2014

(54) DISPOSABLE DENTAL DEVICE WITH REMOVABLE FLOSS AND TOOTHPICK COMBINATION

(71) Applicant: Edward Arthur International, Tampa, FL (US)

(72) Inventors: Ian BERRY, Tampa, FL (US); Gavin BERRY, Tampa, FL (US)

(73) Assignee: Edward Arthur International, Tampa, FL (US)

(21) Appl. No.: 13/907,103

(22) Filed: May 31, 2013

Related U.S. Application Data
(60) Provisional application No. 61/668,615, filed on Jul. 6, 2012.

(51) Int. Cl. A61C 15/00

(52) U.S. Cl. CPC A61C 15/00
USPC 132/309

(57) ABSTRACT

A combination toothbrush, flossing device, and toothpick are provided in a single dental device. A first part of the dental device comprises a toothbrush connected to a stem of the first part, and a second part of the dental device comprises a toothpick attached to a first end and a flossing device connected to a second end. The first part and the second part are detachably attached to each other.

### CROSS-REFERENCE TO RELATED APPLICATIONS

This application claims priority from U.S. Provisional Application No. 61/668,615 filed on Jul. 6, 2012 in the U.S. Patent and Trademark Office, the disclosure of which is incorporated herein by reference in its entirety.

### BACKGROUND

1. Field

The exemplary embodiments generally relate to the field of dental hygiene, and more particularly, to a dental device which comprises a first part with a first stem to which a brush is attached, and a second part with a second stem having a toothpick portion formed at a first end, and a floss portion formed at a second end, the toothpick portion being removably attached to the first stem.

2. Description of the Related Art

Dental hygiene is an essential and important part of everyday activities. In the related art dental devices, multiple devices are normally used in order to properly perform dental hygiene. For example, in order to properly clean the teeth, a toothbrush, in combination with separate dental floss, and a separate toothpick may be needed to clean the teeth. If only one device, for example, a toothbrush, is available, then the user may not be able to properly clean their teeth. Accordingly, the user may not be able to perform proper dental hygiene. It is inconvenient for a user to carry and keep track of separate cleaning devices in order to perform proper dental hygiene.

Accordingly, there is a need for a single device which incorporates a toothbrush, floss, and a toothpick, in order to allow a user to easily and conveniently perform a complete dental hygiene regiment.

### SUMMARY

The present disclosure has been developed in order to overcome the above drawbacks and other problems associated with the related art arrangement. An aspect of the present disclosure provides a single dental device which incorporates a toothbrush, floss, and a toothpick.

According to an exemplary embodiment of the application, there is provided a dental device which comprises a first part having a first stem attached to a brush at a first end, and the first stem having an opening at a second end, and a second part having a second stem and a toothpick portion that is removably inserted into the opening of the first part. The toothpick portion is attached to a first end of the second stem of the second part, and a floss device is attached to a second end of the second stem.

In the dental device of the exemplary embodiment, the floss device and the brush may be in opposite directions to each other in a same plane from a rotational view of the first stem and the second stem.

The floss device comprises two arms which are substantially parallel to each other.

According to an exemplary embodiment of the application, a length of the first part may be 1.5 inches to 3.5 inches, and a length of the second part may be 1.5 inches to 4 inches.

According to an exemplary embodiment of the application, the opening in the first part is in a substantially central part of the second end of the first stem of the first part.

According to an exemplary embodiment of the application, a flossing instrument is connected between the two arms of the floss device.

Other features of the present disclosure will become apparent from the following detailed description, which, taken in conjunction with the annexed drawings, discloses exemplary embodiments.

### BRIEF DESCRIPTION OF THE DRAWINGS

These and/or other aspects of the present disclosure will become apparent and more readily appreciated from the following description of the exemplary embodiments, taken in conjunction with the accompanying drawings of which:

FIGS. 1A, 1B, and 1C illustrate different views of the integrated toothbrush, floss device, and toothpick according to an exemplary embodiment of the present disclosure.

FIG. 2 illustrates different views of the combined dental device according to an exemplary embodiment of the present disclosure;

FIG. 3 illustrates different views of the combined dental device;

FIG. 4 is a diagram of the disassembled first part and second part of the dental device according to an exemplary embodiment of the disclosure;

FIG. 5 is a diagram illustrating a separated view of the first part and the second part of the dental device according to an exemplary embodiment of the disclosure.

FIG. 6 is another diagram illustrating separated views of the first part and the second part of the dental device according to an exemplary embodiment of the disclosure.

FIG. 7 is another diagram illustrating separated views of the first part and the second part of the dental device according to an exemplary embodiment of the disclosure

Throughout the drawings, like reference numerals will be understood to refer to like parts, components and structures.

### DETAILED DESCRIPTION OF THE EXEMPLARY EMBODIMENTS

Hereinafter, certain exemplary embodiments of the present disclosure will be described in detail with reference to the accompanying drawings.

The matters defined herein, such as a detailed construction and elements thereof, are provided to assist in a comprehensive understanding of this description. Thus, it is apparent that the exemplary embodiments may be carried out without those defined matters. Also, well-known functions or constructions are omitted to provide a clear and concise description of exemplary embodiments. Further, dimensions of various elements in the accompanying drawings may be arbitrarily increased or decreased to assist in a comprehensive understanding of the device.

Exemplary embodiments of the present disclosure provide a dental device which facilitates proper dental hygiene by integrating a toothbrush, a floss device and a toothpick into a single structure.

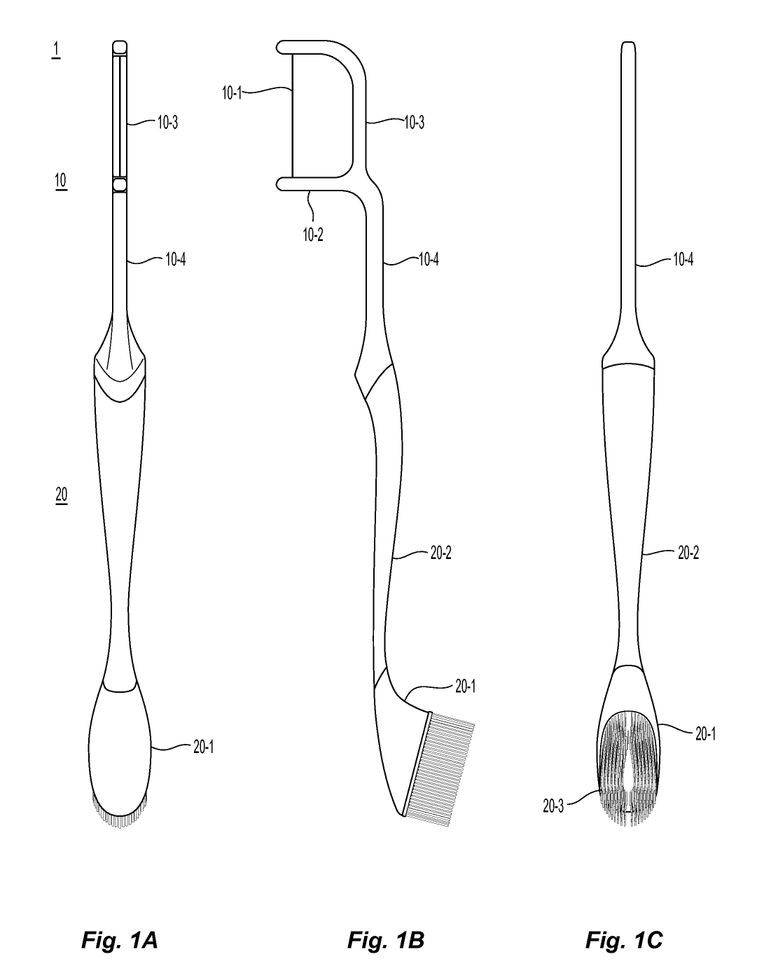

With regard to the figures, the combined toothbrush, floss device, and toothpick are illustrated in FIG. 1. FIG. 1(a) illustrates a rear view of the combined dental device. The combined dental device 1 comprises a first part 20 which comprises a toothbrush portion 20-1 and a first stem 20-2. The first stem 20-2 may have a tapered form, and may be used as a handle for the toothbrush portion of the dental device. The toothbrush portion 20-1 comprises a plurality of bristles and is formed at a first end of stem 20-2. The rear of the toothbrush portion may be implemented with different colors.

The combined dental device 1 further comprises a second part 10 which includes a second stem 10-4, which may be used as a handle for the floss device. As illustrated in FIG. 1(b), the second stem 10-4 comprises a floss device 10-3 which is attached to a second end of the second stem 10-4. The floss device 10-3 may be “U-shaped”, and comprises a pair of floss holding arms 10-2. However, the shape of the floss device is not limited thereto, and the floss device may have other shapes, for example, a “V” shape. The pair of floss holding arms 10-2 each have a means for securely holding floss 10-1. The arms 10-2 are separated by a space such that when the floss 10-1 is attached tightly between the two arms, the floss 10-1 can be used to floss teeth. The arms 10-2 may be substantially parallel to each other.

The length of the first part 20 may be 1.5 inches to 3.5 inches, and the length of the second part may be 1.5 inches to 4 inches. The length of the dental device may be 3.5 inches to 7.5 inches.

FIG. 1(c) illustrates a front view of the combined dental device. As shown in FIG. 1(c), the bristles 20-3 of the toothbrush portion 20-1 may be oval-shaped. However, this is only exemplary, and any shaped head may be used.

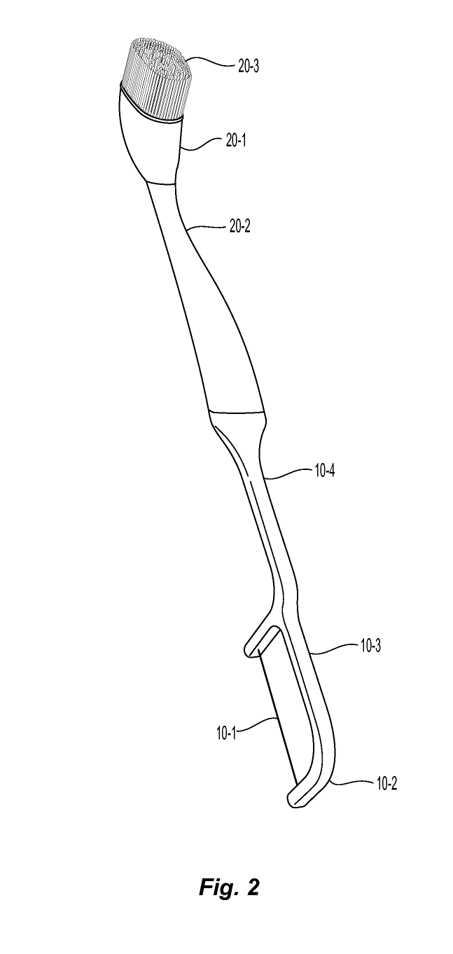

FIG. 2 illustrates another view of the combined dental device. As illustrated in FIG. 2, the floss device 10-3 and the brush device 20-1 may be in opposite directions to each other in the same plane from a rotational view of the first stem and the second stem. However, this is only exemplary, and the floss device 10-3 and the brush device 20-1 may be positioned to face in the same direction.

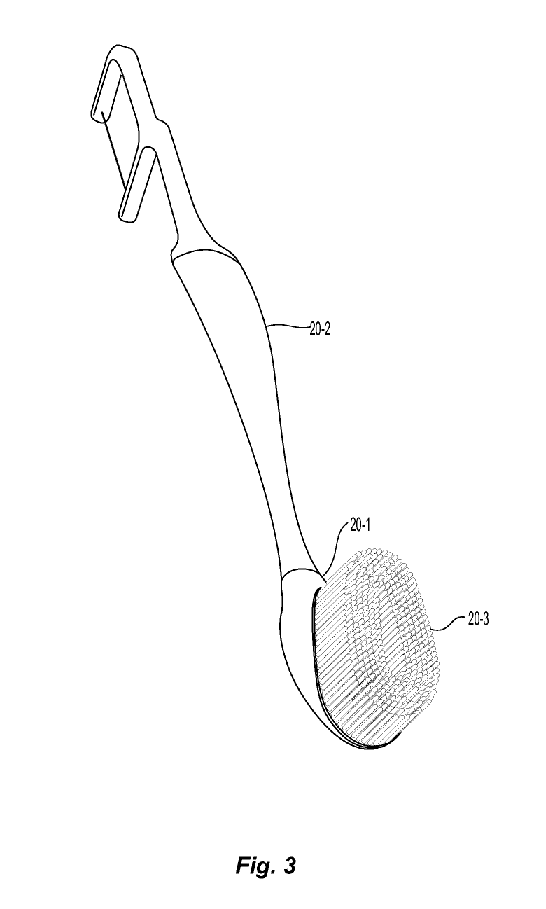

FIG. 3 is a view of the first part 20 of the combined dental device. As shown in FIG. 3, and as discussed above, the bristles 20-3 of the brush 20-1 may be formed in an oval shape. An area or areas on brush 20-1 may be formed to allow for a dentifrice composition.

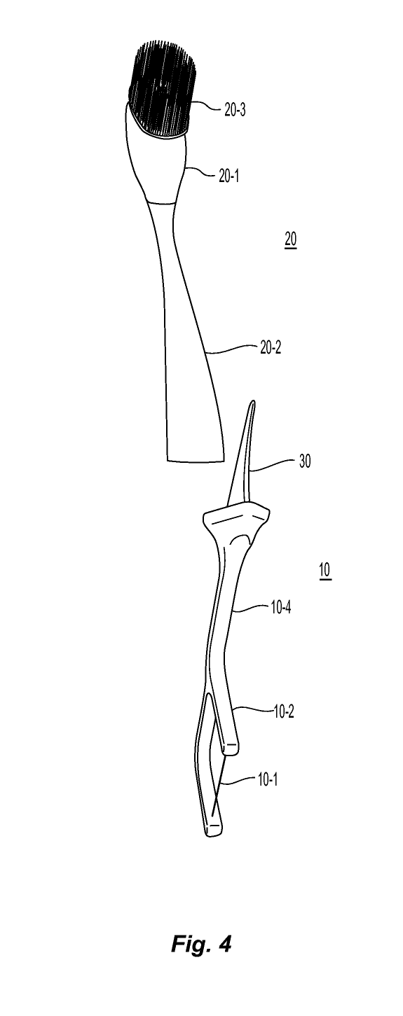

FIG. 4 illustrates the combined dental device according to another exemplary embodiment. As shown in FIG. 4, the second part 10 comprises a toothpick portion 30 which is formed at a first end of the second stem 10-4. The toothpick 30 is formed at substantially the center of the lower end of the first end of the second part 10. The toothpick 30 is formed to be removably inserted into an opening that is formed in an end of the first part 20 that is opposite to the head 20-1 of the first part 20.

The toothpick portion 30 may have a tapered form, and is removably inserted into the opening formed at the end of the first part so that the first part is detachably attached to the second part.

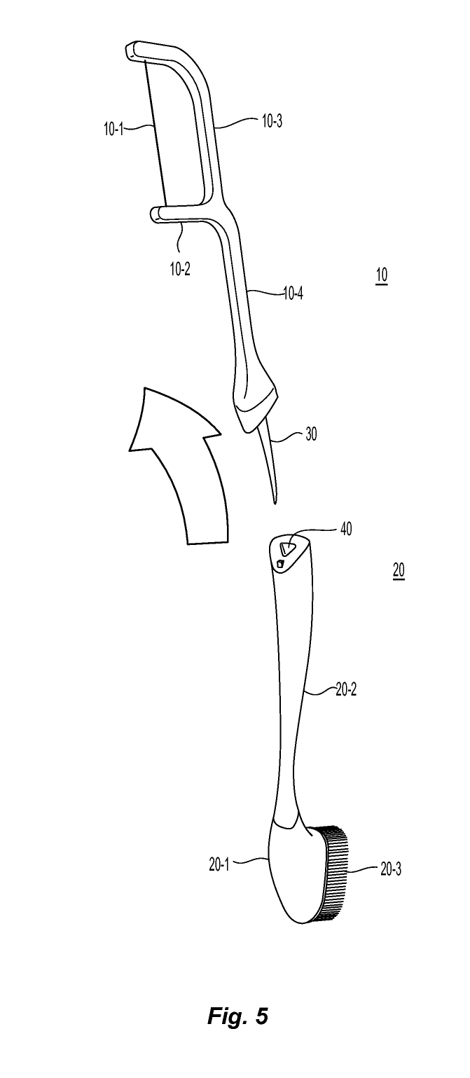

FIG. 5 is a view according to an exemplary embodiment which illustrates a separated view of the first part 20 and the second part 10 of the dental device. As shown in FIG. 5, the toothpick portion 30 of the second part 10 is removably inserted into the hole 40 which is located at an end of the first part 20. The hole 40 may be triangular shaped. However, this is only exemplary, and any shaped hole may be used in order to securely attach the first part 20 and the second part 10.

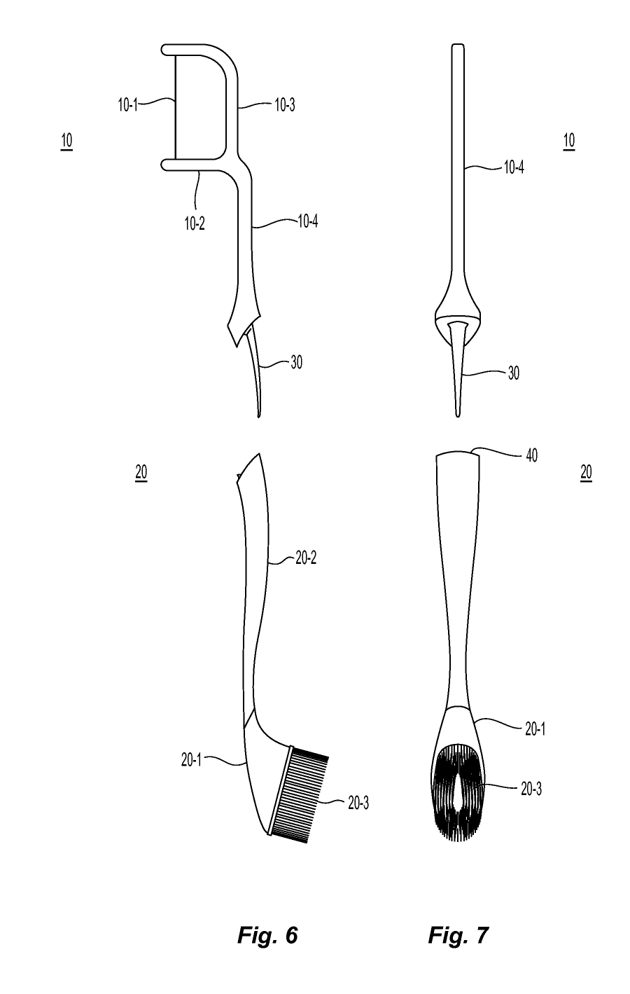

FIG. 6 is another view which illustrates the separated first part 20 and second part 10 of the dental device.

While the exemplary embodiments of the present disclosure have been described, additional variations and modifications of the exemplary embodiments may occur to those skilled in the art once they learn of the basic inventive concepts. Therefore, it is intended that the appended claims shall be construed to include both the above exemplary embodiments and all such variations and modifications that fall within the spirit and scope of the inventive concepts.

What is claimed is:

1. A dental device comprising:
a first part having a first stem attached to a brush at a first end, and the first stem having an opening at a second end;
a second part having a second stem and a toothpick portion that is removably inserted into the opening of the first part,
wherein the toothpick portion is attached to a first end of the second stem of the second part, and a floss device is attached to a second end of the second stem.

2. The dental device of claim 1, wherein the floss device and the brush are in opposite directions to each other in a same plane from a rotational view of the first stem and the second stem.

3. The dental device of claim 1, wherein the floss device comprises two arms which are substantially parallel to each other.

4. The dental device of claim 1, wherein a length of the first part is 1.5 inches to 3.5 inches, and a length of the second part is 1.5 inches to 4 inches.

5. The dental device of claim 1, wherein the opening is in a substantially central part of the second end of the first stem of the first part.

6. The dental device of claim 3, wherein a flossing instrument is connected between the two arms of the floss device.
